(19) United States
(12) Patent Application Publication
(10) Pub. No.: US 2017/0295132 A1
(43) Pub. Date: Oct. 12, 2017

(54) EDGE CACHING OF HTTPS CONTENT VIA CERTIFICATE DELEGATION

(71) Applicant: INTERDIGITAL PATENT HOLDINGS, INC., Wilmington, DE (US)

(72) Inventors: Jun Li, Cranbury, NJ (US); Debashish Purkayastha, Collegeville, PA (US)

(73) Assignee: INTERDIGITAL PATENT HOLDINGS, INC., Wilmington, DE (US)

(21) Appl. No.: 15/504,148

(22) PCT Filed: Aug. 14, 2015
(86) PCT No.: PCT/US2015/045263

§ 371 Date: Feb. 15, 2017

Related U.S. Application Data
(60) Provisional application No. 62/037,920, filed on Aug. 15, 2014.

(51) Int. Cl. H04L 29/12; H04L 29/08

(52) U.S. Cl. CPC H04L 61/1511; H04L 67/2842; H04L 61/1588; H04L 61/3015; H04L 61/6013

(57) ABSTRACT

Mechanisms may be used for edge caching Hypertext Transfer Protocol Secure (HTTPS) content via an owner-endorsed proxy. The edge servers of a mobile-content distribution network (CDN) may work as the proxy that dynamically gets the means to serve HTTPS content through rights delegated by content owners. Mechanisms may include dynamically assigning a domain with a Canonical name (CNAME) record in DNS based on the popularity of the domain at an edge server. Each edge server from the plurality of edge servers may be associated with a mobile content distribution (mobile-CDN) network, via the mobile-CDN, the right to establish a transport layer security (TLS) session is delegated to the edge server on behalf of the content owner, so that the HTTPS request to the content server may be served by the edge server. A mechanism to restrict the scope of HTTPS content served through the delegated right is presented as well.

### CROSS REFERENCE TO RELATED APPLICATIONS

This application is the U.S. National Stage, under 35 U.S.C. §371, of International Application No. PCT/US2015/045263 filed Aug. 14, 2015, which claims the benefit of U.S. Provisional Application No. 62/037,920 filed Aug. 15, 2014, the contents of which are hereby incorporated by reference herein.

### BACKGROUND

Hypertext Transfer Protocol Secure (HTTPS) may be used in a variety of applications for private content or for publicly available content. The wide use of HTTPS may cause content distribution network (CDN) technologies to fail to operate. CDN operators may use edge caching to offload network traffic for their clients, including for example content owners or internet service provider (ISP) operators. Due to the end-to-end encryption by a security socket layer and/or transport layer security (SSL/TLS, hereinafter TLS) session for HTTPS, content requests and/or responses may not be visible by edge servers. As a result, storing to and retrieving HTTPS content from caches may not be possible.

### SUMMARY

Mechanisms may be used for edge caching Hypertext Transfer Protocol Secure (HTTPS) content via an owner right delegation process over a mobile-content distribution network (CDN), which may contain edge servers dynamically obtaining the ability to serve HTTPS content. Each edge server from the plurality of edge servers may use the ability to serve HTTPS content to enable a transport layer security (TLS) session setup for an HTTPS request to the content server and then may serve HTTPS content on behalf of the content server. Mechanisms may include dynamically assigning a Canonical name (CNAME) based on the popularity of the content owner's domain at the edge server locations. Mechanisms may also include a multi-level right delegation from content owner to edge servers through a mobile-CDN operator. Mechanisms may also include approaches to verify content integrity when content is served through a delegated right.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of an example TLS session for Hypertext Transfer Protocol Secure (HTTPS) content caching;

FIG. 3 is diagram of an example certificate distribution procedure using a man in the middle (MITM) proxy server to break an HTTPS connection into two legs;

FIG. 4 is a diagram of a certificate distribution procedure with private key;

FIG. 5 is an example location map of Amazon's CLOUDFRONT edge servers;

FIG. 6 is a diagram of an example of public key infrastructure (PKI) certificates and delegations;

FIG. 7 is a diagram of an example small cell network (SCN) 700 using approaches for proxy certificates (PCs) and attribute certificates (ACs) to enable HTTPS caching;

FIG. 8 is a diagram of an example mobile content distribution (CDN) system architecture;

FIG. 9 is a diagram of an example HTTPS caching procedure for an edge server with owner delegated rights;

FIG. 10 is a diagram of an example HTTPS request procedure using a popularity metric;

FIG. 11 is a diagram of an example dynamic canonical naming (CNAME) procedure;

FIG. 12 is a diagram of an example proxy certificate delegation procedure; and

FIG. 13 is a diagram of an example attribute certificate delegation procedure to a mobile-CDN service;

FIG. 14 is a diagram of an example attribute certificate delegation procedure acting directly to edge servers;

FIG. 15 is a diagram of an example on-demand session key delegation procedure;

FIG. 16 is a diagram of an example multi-level certificate management procedure; and

FIG. 17 is a diagram of an example procedure over non-original certificate.

### DETAILED DESCRIPTION

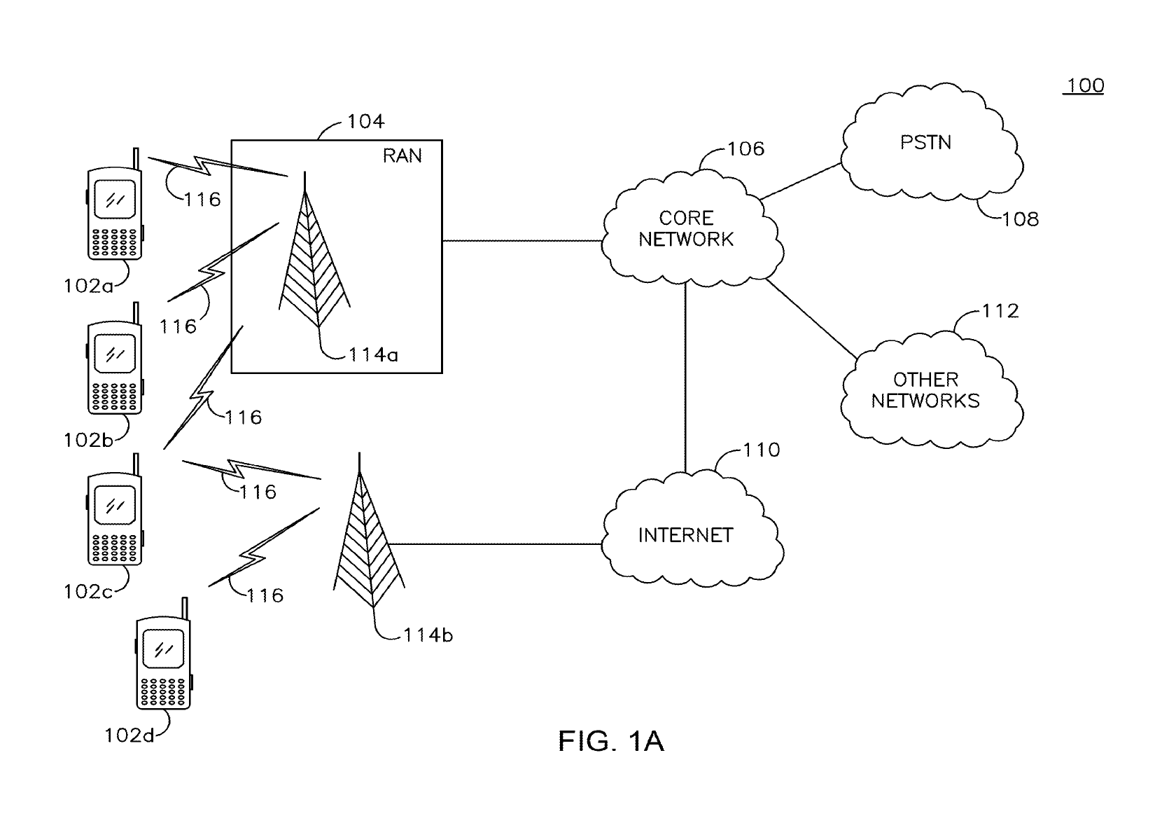

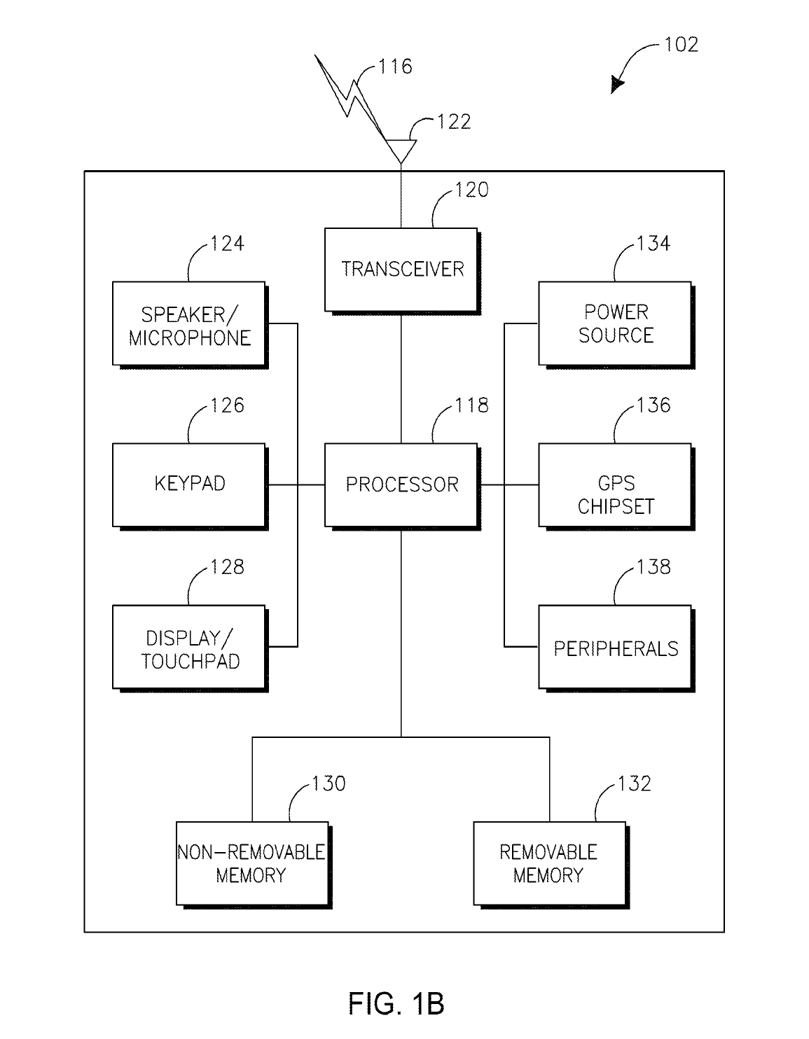

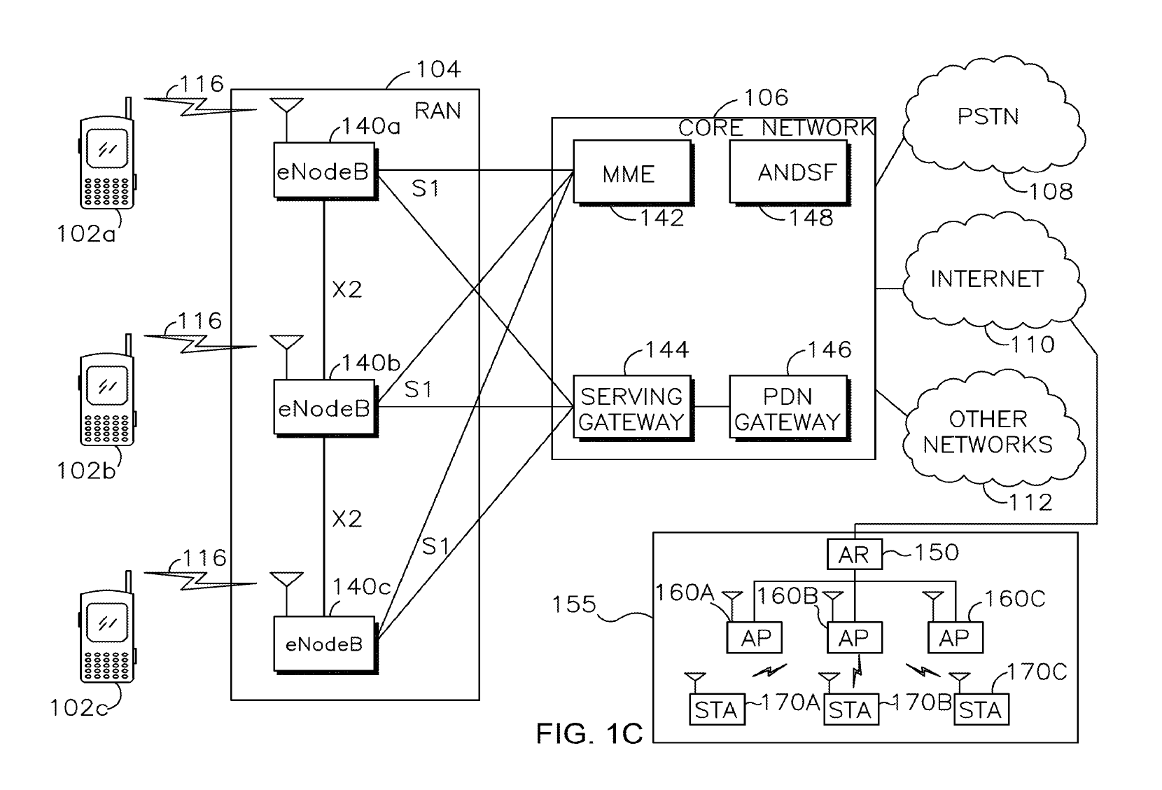

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Edge caching may be a challenge for Hypertext Transfer Protocol Secure (HTTPS) content due to the use of end-to-end encryption in Internet communications between a browser and a web server. For example, in order to address the challenges in storing and retrieving HTTPS content to/from caches, CDN operators may use HTTPS caching solutions such as the following solutions: redirecting an original uniform resource locator (URL) to a CDN's URL; and/or redirecting the URL's domain to CDN's IP addresses.

The former solution may use URL redirection at a content server. The redirection may be achieved by rewriting hyperlinks in the webpage at the content server or dynamically returning a new URL back to the browser, for example. With URL redirection, the requester's browser may see content served by the CDN's domain with redirected URLs in the address bar. The latter solution may have a content owner add a canonical naming (CNAME) record in the DNS servers so that the original URL's domain may be resolved to the IP address of an edge server in the CDN's domain. The requester's browser may continue to see the original URLs in the address bar although the content may actually be served by an edge server.

Big CDN operators, such as Amazon CLOUDFRONT and AKAMAI SECURE-CDN offer both options. The second option is the primary solution for HTTPS content caching because it is important for consumers to see the original URL in the address bar for HTTPS content.

A challenge for the second option may include the need to procure content owners' certificates. CDN edge severs install the private keys of all content owners it serves. Then a TLS session may be established between a browser and an edge server for any content with an HTTPS URL. This requirement may introduce security risks for content owners.

Increasing Internet speed, in both core and access networks, makes content owners less likely to use CDNs, especially when they want to use HTTPS. However, edge caching may be utilized in mobile networks. The fast growth of smartphones and their broadband needs promote small cell network (SCN) deployment in current mobile operator networks. As the density of small cells increases, the backhaul resources may become scarce. Edge caching may reduce the backhaul pressure in high density small cell mobile networks. However, some solutions of Internet CDN operators may not be suitable for mobile networks with a large number of small cells. Unlike the Internet CDN whose edge caches are securely guarded in big data centers, the edge caches of a mobile-CDN may be located in homes, public hotspots or moving facilities, which may be more vulnerable to security attacks. In these scenarios, edge caches may present a higher risk of certificates being compromised.

A mobile-CDN architecture may use one or more delegated rights to support HTTPS content caching at edges, as described herein. An edge server may use the right to support key exchanges for transport layer security (TLS) session setup on behalf of the content owner so the client browser can trust the edge server to serve content with HTTPS URLs. Approaches described herein include: a mechanism for dynamically adding CNAME records in DNS servers with adaptive coverage of small cell mobile network; the use of a proxy certificate and/or attribute certificate for edge caching in mobile networks; and a dynamic mechanism of right authorization from a content owner to edge servers via mobile-CDN service system architecture to enable an edge server to serve HTTPS content on behalf of the content owner. Definitions of acronyms used herein are summarized in Table 1.

TABLE 1

| | |
|---|---|
| CA | Certificate Authority |
| CDN | Content Delivery/Distribution Network |
| CE-GW | Content Enablement Gateway |
| CES | Content Enabled Server |
| CN | Core Network |
| DNS | Domain Name Server |
| DLNA | Digital Living Network Alliance |
| eNodeB | evolved NodeB |
| HeNB | Home eNodeB |
| HNB | Home NodeB |
| HSS | Home Subscriber Server |
| HTTPS | HTTP Secure |
| PKI | Public Key Certificate Infrastructure |
| L-GW | Local Gateway |
| LIPA | Local IP Access |
| QoE | Quality of Experience |
| NFS | Network File System Protocol |
| RTSP | Real Time Streaming Protocol |
| SCN | Small Cell Network |
| SSL | Secure Socket Layer |
| TLS | Transport Layer Security |
| UPnP | Universal Plug and Play |
| UE | User Equipment |

In a browser, an HTTPS request may be processed using any of the following steps: a domain name server (DNS) request may be sent to obtain the IP address of the domain in the request URL; a TCP connection to the IP address and port 443 may be established; and/or over the TCP connection, a secure socket layer or transport layer security (SSL/TLS, henceforth TLS) protocol may use the certificate of the URL's domain to perform a key exchange and agree on a session key. The requested URL may be sent and the corresponding response may be received with the encryption of the session key.

HTTPS may be used in web applications, for example for any of the following uses: to secure content transmission (e.g. bank transactions); to provide content integrity guarantee; to provide content usage pattern privacy; and/or to provide content distribution performance. Secure content transmission is an example purpose of HTTPS, where content may be private to users and may not be cached. However, when HTTPS is used for other purposes, caching may be allowed in case the content is publically available to any user.

HTTPS may also be used for distribution performance. Establishing TLS sessions may increase the delay of content responses. For example, AKAMAI's edge caching for HTTPS performs worse without edge caching. However, Google's SPDY protocol may become part of HTTP 2.0 specifications, which intends to speed up web applications by using a single TCP connection for multiple requests (i.e. TCP persistent). SPDY may use a TLS session over the TCP session. As the HTTP 2.0 is adopted by more and more web applications, it may be equivalent to using HTTPS for all content including public content. HTTPS may be used everywhere because mixing HTTP and HTTPS in a web application has been identified to be a security vulnerability. For example, when a small portion in a page needs to be protected by HTTPS, the whole page should be protected. However, if HTTPS is used everywhere in this way, edge caching may be a challenge to CDN operators, and especially to mobile-CDN operators.

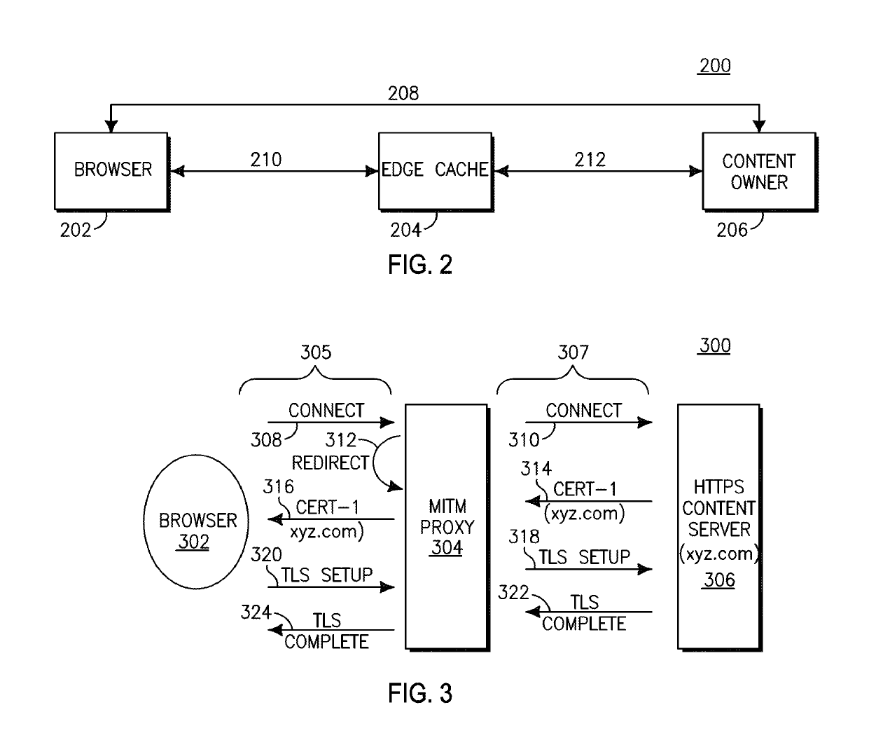

Edge Caching may be used for HTTPS content. FIG. 2 is a diagram of an example TLS session 200 for HTTPS content caching. FIG. 2 shows a browser 202, an edge cache 204 (also referred to as edge server, for example AKAMAI's edge server), and a content owner (e.g. YouTube). Using the HTTPS protocol, the browser 202 may setup a TLS session 200 by using a public key infrastructure (PKI) certificate (PKC) that matches the domain in the HTTPS content URL. If the PKC doesn't match the domain, the browser 202 may post a warning message and quit the request of the content.

In order to retrieve HTTPS content from an edge cache 204, the TLS session 200 may be broken into two sessions: TLS session 210 from the browser 202 to the edge cache 204 and TLS session 212 between the edge cache 204 and the content owner 206. TLS session 208 shows an example scenario where the edge cache 204 is not used or available, such that the browser 202 may set up a TLS session 208 using PKC_{youtube} directly with the content owner 206, such that the browser 202 may obtain a session key K₀ based on PKC_{youtube}.

In an example involving edge cache 204, when the browser's 202 HTTPS request in TLS session 210 is redirected to the edge cache 204, the browser 202 may try to setup a TLS session 210 with the edge cache 204. The edge cache 204 may use PKC_{youtube} to setup TLS session 212 to download the cacheable content using session key K₁. Unless the edge cache 204 procures PKC_{youtube}, it may have to offer a different certificate PKCₚ to browser 202 to establish TLS session 210

An edge server may obtain an authorized right to serve content from a content owner in many ways including, but not limited to, any of the following techniques: man-in-the-middle (MITM) Proxy; URL redirection; or owner's certificate procurement. These techniques are described in further detail below.

As a MITM proxy, an edge server may hold a root certificate authority (CA) for the browser. For example, this approach may be used in an enterprise network, where all browsers are installed by the enterprise's information technology (IT) department. A CA inside the enterprise network may be set in all web browsers as the root CA. The enterprise CA may issue a PKI certificate for any domain to be used to establish a TLS session between the browser and the edge server. This MITM interception may be transparent to clients and/or servers.

FIG. 3 is diagram of an example certificate distribution procedure 300 using a MITM proxy server to break an HTTPS connection into two legs 305 and 307. When an HTTPS request to connect 308 is made by a browser 302, the browser 302 may obtain the IP address of the URL's domain (e.g. from a DNS server, not shown), referred to as domain xyz.com in this example. A request to setup a TLS session may be sent to the IP address of xyz.com by the browser 302. The MITM proxy 304 may intercept messages of TLS establishment such as connect message 308, which may be in clear text. The MITM proxy 304 may redirect the messages to its own address, at 312.

The MITM proxy 304 may dynamically create a certificate cert-2 for xyz.com signed by its own CA. Since the client browser 302 sees the proxy's CA as a legitimate CA, the browser 302 may accept the received certificate cert-2 316 from the MITM proxy 304 and use it for a TLS session between the browser 302 and the MITM proxy 304 via TLS setup message 320 and TLS complete message 324. The MITM proxy 304 may also request a TLS session setup to the original server 306 by sending a connect messages 310 and using the received certificate cert-1 314 from the server 306. The MITM proxy 304 may setup the TLS session via TLS setup message 318 and TLS complete message 322. The MITM proxy 304 may have session keys of both TLS sessions or legs 305 and 307. Any request and response to/from the content server 306 may be decrypted and re-encrypted by the MITM proxy 304 and relayed to the content server 306 and/or the browser 302. The MITM proxy 304 may see all data, including HTTPS request and responses, over this two-leg TLS session 305 and 307 in clear text.

An MITM proxy may be used for edge caching. In this case, the clients must trust the proxy where there is no privacy for them, including the exposure of their bank transactions. For example, an enterprise network may enforce it on company-owned clients. This solution may not be suitable in a public network, where the browsers on the mobile terminals are downloaded directly from browser vendors. The mobile-CDN operator may not have a right to enforce its CA as the root CA in browsers of mobile terminals.

Another technique is to directly authorize content to be served on an edge server by URL redirection. URL redirection may redirect the original URL to a URL at the CDN's domain, for example by rewriting hyperlinks in the web pages or returning a new URL upon every URL request. For example, an original URL, https://youtube.com/124, may be redirected to a new URL, https://Akamai.com/youtubedotcom/124. Since the browser may see the content is at the CDN's domain, it may need the certificate of the CDN's domain (e.g. Akamai.com) to setup a TLS session. This approach may require the content owner to deploy a CDN operator's programs at the content server to dynamically rewrite webpages or redirect URL requests. Even if a content owner trusts a CDN operator and its programs, the content owner may be reluctant to use this approach because its own domain name may not be shown or may be shown only as a parameter in the URL in the address bar. This may in turn negatively affect the content owner's public image.

Another technique for use in edge caching is certificate procurement, which may be used by CDN operators for example. The content server's domain may be resolved to an edge cache's IP address by using a DNS Canonical Naming (CNAME) record. A CNAME record may map a domain name X to another domain name Y. A CDN operator may request a content owner to register a CNAME record that maps the content server domain to the CDN edge server's domain. The DNS may request a content URL that may return an edge server's IP address instead of the content server's IP address.

Using a CNAME record, the browser address bar may display the original URL of the content request. As a result, content owners may use the CDN service and retain the publicity of their own domains. However, since the domain remains unchanged in the browser, the browser may need to verify a certificate of the original domain in the process of establishing the TLS session. A content owner may distribute its domain certificate including the private keys to the edge servers, for example using certificate procurement by edge servers.

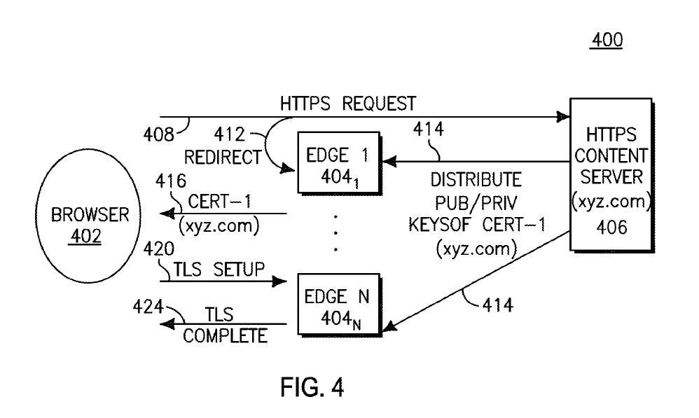

FIG. 4 is a diagram of a certificate distribution procedure 400 with private key. The content server 406 may distribute certificate cert-1 in message(s) 414 to one or more edge servers 404₁-404_{N}. An original HTTPS request 408 to domain xyz.com may be resolved to the IP address of edge server 404₁. The HTTPS request 408 for the TLS session may be redirected via 412 to edge server 404₁. The browser 402 may verify the certificate cert-1 of domain xyz.com given by message 416 from edge server 404₁. A TLS session may be setup between the browser 402 and the edge server 404₁ by exchanging TLS setup message 420 and TLS complete message 424 using certificate cert-1.

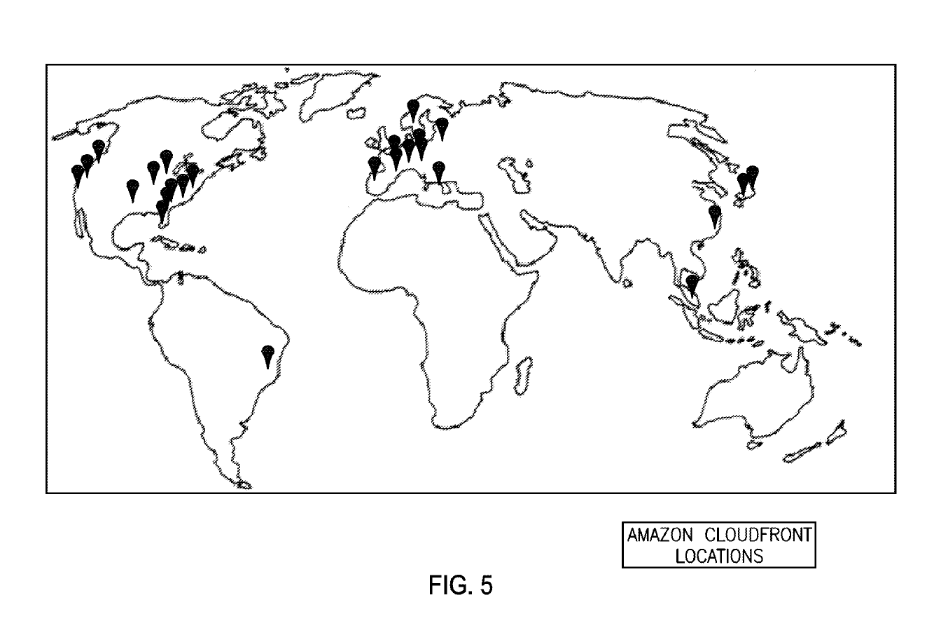

In an example, AKAMAI's Secure-CDN and Amazon's CLOUDFRONT may implement certificate procurement. Secure CDN and CLOUDFRONT may possess the private keys of their clients, the content owners. For large CDN operators, edge servers may be located in physically and technically secured data centers. FIG. 5 is an example location map of Amazon's CLOUDFRONT edge servers, showing approximately a few dozen worldwide. For small cell networks, millions of small edge caches may be located in homes and/or public hotspots, and the risk of losing the private key of the content owner may be high. Any loss of the private key may cause service disruption of the content owner's service and replacing a certificate may be costly.

As described above, the PKC may be specified, for example, in the International Telecommunication Union (ITU) standard X.509. A PKC may have an issuer and a subject. The issuer may be a CA and the subject may be another CA or an end entity certificate (EEC). The certificate of the top level CA, referred to as the root CA, may be self-signed and the issuer and the subject of the root CA may be the same. An EEC may have a chain of CAs, and a browser may verify an EEC if one of the CAs on the chain is trusted, for example, in the case that the CA's certificate is included in the browser's trusted CA pool.

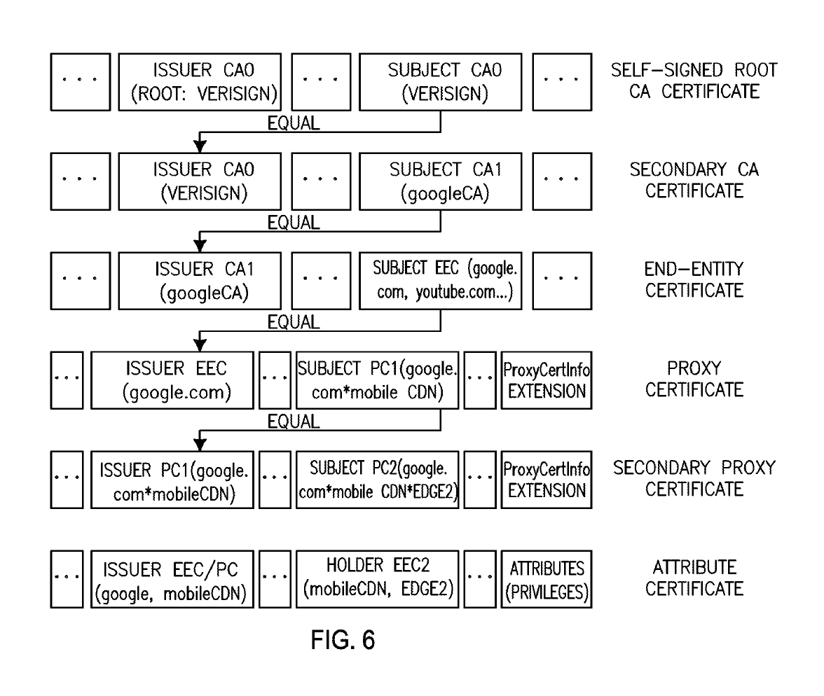

FIG. 6 is a diagram of an example PKI certificates and delegations, where Verisign is the root CA and googleCA is a secondary CA. In this example, google.com* is the subject of an ECC, which also includes youtube.com in its subject alternative names (SAN). FIG. 6 further illustrates the chain of CAs using PKCs including, but not limited to: a self-signed root CA certificate, a secondary CA certificate, an end-entity certificate, a proxy certificate, a secondary proxy certificate and/or an attribute certificate.

An EEC for a subject may be an asset that may be valid for a long term period of time. For example, a current certificate may have limited validity and have alternative subject names such as, for example, google.com, android.com, and youtube.com. If the private key of the certificate is compromised, all services at the alternative subject names may be faked during the time that the certificate is valid. As a result, a service provider may not trust an edge cache to get hold of its private key, even if the cache may belong to a recognized CDN (e.g. Amazon). To minimize the risk of private key exposure, an EEC owner may issue a proxy certificate (PC) to another end entity, and may delegate the PC's identity later. Since the subject field of a PC may be the issuer name appended by a unique name among all PCs of the issuer, the PC may hold the identity of the issuer and may perform certain actions on behalf of the issuer.

According to an example, an X.509 PC may be specified in Internet Engineering Task Force (IETF) Request for Comments (RFC) 3820. A PC may have a restricted certificate policy comparing with the issuer's certificate policy and may have a much shorter validity time. In this case, the owner of a PC may further issue a secondary PC to another end-entity with further restrictions. In the example in FIG. 6, issuer EEC google.com may issue subject PC1 to mobileCDN.com. Issuer PC1 may further issue subject PC2 to edge2.mobileCDN.com. A PC may have an extension field ProxyCertInfo extension to indicate it is a proxy certificate.

If the private key of a PC is compromised, it may only affect one end entity during a short period of time. Proxy certificates may be widely used in grid computing where each grid must be authorized to execute code on behalf of a centralized entity. Instead of delegating its identity by using a proxy certificate, an end entity may also delegate its attributes or privileges to another end entity by using an attribute certificate (AC). For example, an attribute certificate may be specified according to ITU X.509 or IETF RFC 3281.

In the example of FIG. 6, the issuer may be an attribute authority (AA) which may be either an AC owner or an EEC owner. As shown in the example of FIG. 6, the issuer as an AA may include googleCA, google.com, and/or mobileCDN.com. The holder of the AC may be an end entity, such as mobileCDN.com or edge2.mobileCDN.com. The issuer google.com may bundle a caching privilege or attribute to edge2.mobileCDN.com. The privilege may imply that google.com may trust that edge2.mobileCDN.com would not alter the properties and the integrity of content from google.com. An AC may also be short lived and may be re-issued much more frequently than the issuer's certificate. For example, if a certificate is considered a passport which may identify the holder, then a proxy certificate may be considered a temporary passport and an attribute certificate may be considered a visa stamped on a passport. A compromised AC may have no value unless the holder's EEC is also compromised, in which case there is less risk for a content owner to delegate its privileges of content handling to third parties such as edge caches.

Edge caching may become difficult for HTTPS content use due to the protocol enforcing an end-to-end encryption between a browser and a web server. Solutions by large CDN operators may use procurement of content owners' certificates including their private keys, which may impose a high security risk to content owners, especially in a mobile-CDN with a large number of small cell edge servers. Any compromise of a small cell edge server, which may be at a public hotspot or a customer's home, may lead to a loss of the private keys of content owners.

Approaches for using proxy certificates (PCs) and attribute certificates (ACs) in small cell networks (SCNs) to enable HTTPS caching are described herein. A popularity-based DNS resolution feature may be used in a DNS. Multi-level certificate issuing and revoking procedures may be used. Additionally, content integrity validation may be achieved by adding conditions on the “cache_control” field in the HTTPS response header.

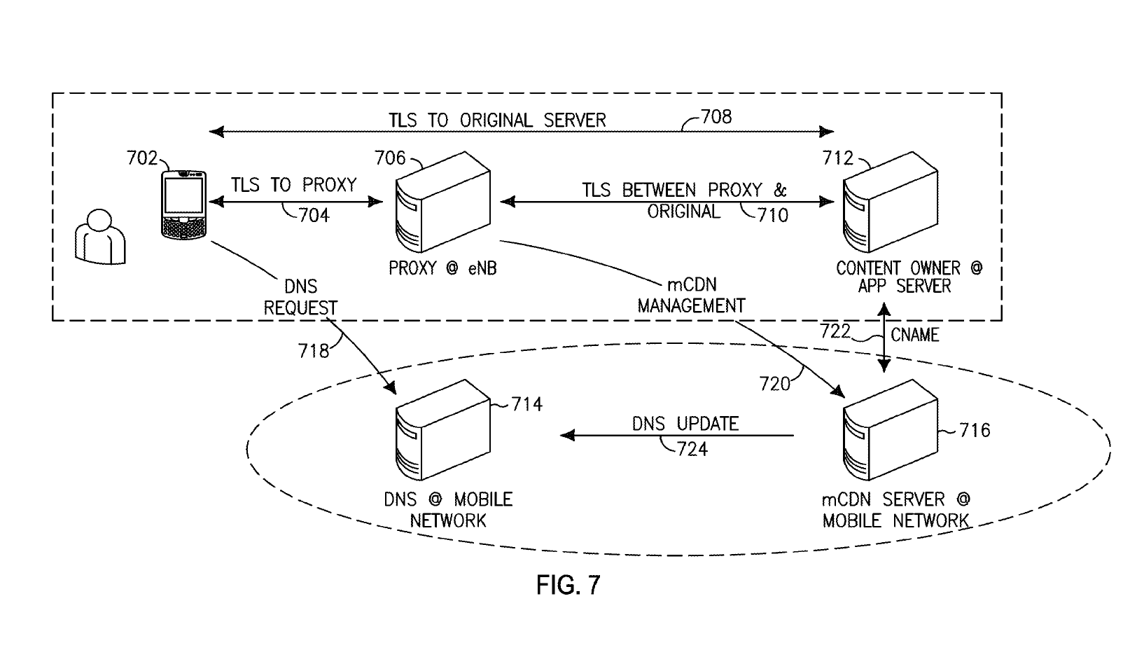

FIG. 7 is a diagram of an example small cell network 700 where the above approaches for using PCs and ACs may be used to enable HTTPS caching through breaking the TLS session 708 between browser 702 and content server 712 into two legs, TLS session 704 between browser 702 and proxy server 706, and TLS session 710 between proxy server 706 and content server 712. The enabling process may involve DNS server 714 in the mobile network and the messages for DNS request 718, and DNS update 724 for CNAME record 722. The enabling process may involve a mobile CDN management 720 function, which may handle right delegation for content owners 712 to the proxy servers 706. Mechanisms for right delegation may minimize the risk of security being compromised through a hierarchical structure using a mCDN service 716 as an intermediate trust entity. With a TLS session 704 setup by an authorized certificate, the browser 702 may obtain HTTPS content from the proxy server 706.

The methods and apparatuses described herein may use limited rights delegated from a content owner instead of fully procuring the original certificates. Since the delegated rights may have their limits or constraints associated with a location and valid for a time period much smaller than the original certificates, the risk of being compromised may be minimized. A dynamic CNAME may redirect the domain of a content server to a domain of a mobile-CDN service. A dynamic right delegation may include, but is not limited to, any of the following: identity delegation via a proxy certificate, privilege delegation via an attribute certificate, and an on-demand session key delegation via real-time authorization.

Mechanisms described herein may build a short time relationship between content owners and edge servers, which may be designed for a mobile-CDN with a large number of small cell edge servers at insecure environments. The mechanisms may allow an edge server to dynamically request a right delegation from a content owner in order to serve HTTPS content on behalf of the content owner. For example, mechanisms may include, but are not limited to, the following: applying a proxy certificate and attribute certificate in edge caching technology; dynamic mechanisms of CNAME and location dependent use of CNAME records; and/or dynamic mechanisms of a right delegation procedure.

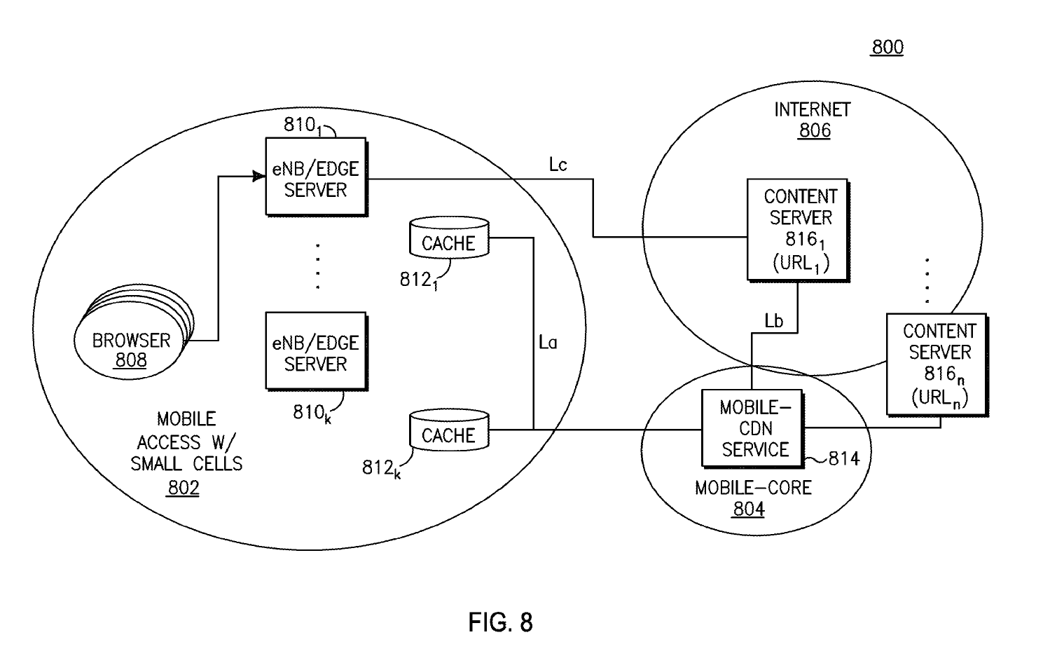

A mobile-CDN system architecture in a mobile network with small cells may try to reduce the backhaul pressure of small cell eNBs, for example at peak hours, to thereby provide a better quality of experience (QoE) to mobile users. FIG. 8 is a diagram of an example mobile CDN system architecture 800. Browser(s) 808 may have mobile access with small cells 802, for example to content servers 816₁ . . . 816ₙ. The mobile-CDN service 814, which may be located in a mobile core 804, may have two interfaces: interface La to edge caches 812₁ . . . 812ₖ and interface Lb to other content servers (owners) 816₁ . . . 816ₙ. The content servers 816₁ . . . 816ₙ may be connected via the Internet 806, and may be web applications, for example. The mobile-CDN service 814 may facilitate the content distribution between content servers 816₁ . . . 816ₙ and edge caches (servers) 812₁ . . . 812ₖ through interface Lc.

The mobile-CDN service 814 may have functions including, but not limited to, the following: giving a recommendation of what to pre-fetch to edge servers 812₁ . . . 812ₖ; and/or obtaining the authority to serve content at edge servers 812₁ . . . 812ₖ. In an example, when content server 816ₙ with URLₙ is an HTTPS URL, and a browser 808 under edge server 810ₖ requests URLₙ, edge server 810ₖ may not be able to see URLₙ unless content server 816ₙ performs tasks that authorize it, such as for example: the DNS (not shown) may resolve URLₙ to the IP address of edge server 810ₖ, and/or edge server 810ₖ may bear a right to setup a TLS session on behalf of content server 816ₙ. For example, the task of the DNS resolving URLₙ may be done using a CNAME record. A CNAME record in a DNS server may map domain X (URLₙ) to a domain Y (eNB).

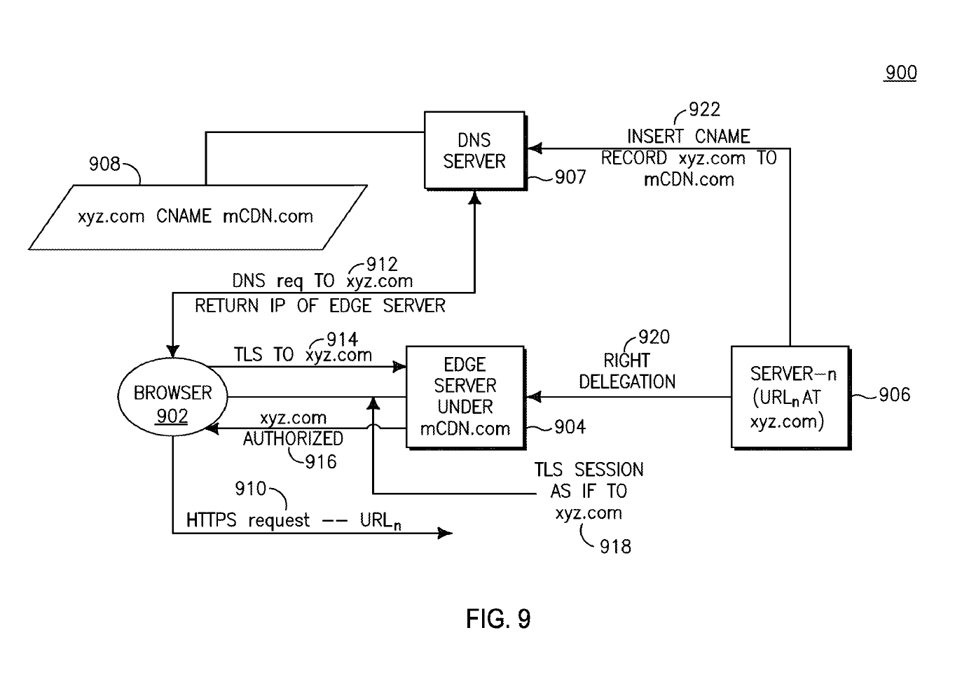

FIG. 9 is a diagram of an example HTTPS caching procedure 900 for an edge server 904 with owner delegated rights. According to the example of FIG. 9, at 922, a content server 906 (e.g. URLₙ at xyz.com) may insert a CNAME record that creates a mapping 908 of domain xyz.com to domain mCDN.com in the DNS server 907. If browser 902 makes a request 910 to URLn, assuming URLₙ is HTTPS, at 912, the browser 902 may first send a DNS request to resolve the URLₙ's domain xyz.com, the DNS server 907 may resolve xyz.com to mCDN.com based on the CNAME record, and the DNS server 907 may return a mCDN.com IP address to the browser 902.

At 920, in order for the edge server 904 to bear a right to setup a TLS session on behalf of content server 906, rights may be delegated from the content owner 906 to the edge server 904. At 916, edge server 904 may act as an authorized entity for domain xyz.com to setup a TLS session 914 with the browser 902. At 918, the content of URLₙ may be served over the TLS session 914 from edge server 904 to the browser 902 as if from domain xyz.com.

The tasks shown in FIG. 9 may be done by the content server 906 directly, for example the content server 906 may insert the CNAME record to DNS server 907. The content server 906 may directly delegate rights to edge server 904. These tasks may be performed upon request of edge servers via mobile-CDN services through the system architecture of FIG. 8. One or more of the tasks shown in FIG. 9 may enable any of the following: the DNS server 907 to resolve the request of xyz.com to the IP address of edge server 904; and/or a TLS session being set up from a browser 902 to the edge server 904 as if it is being set up for the server 906 at xyz.com.

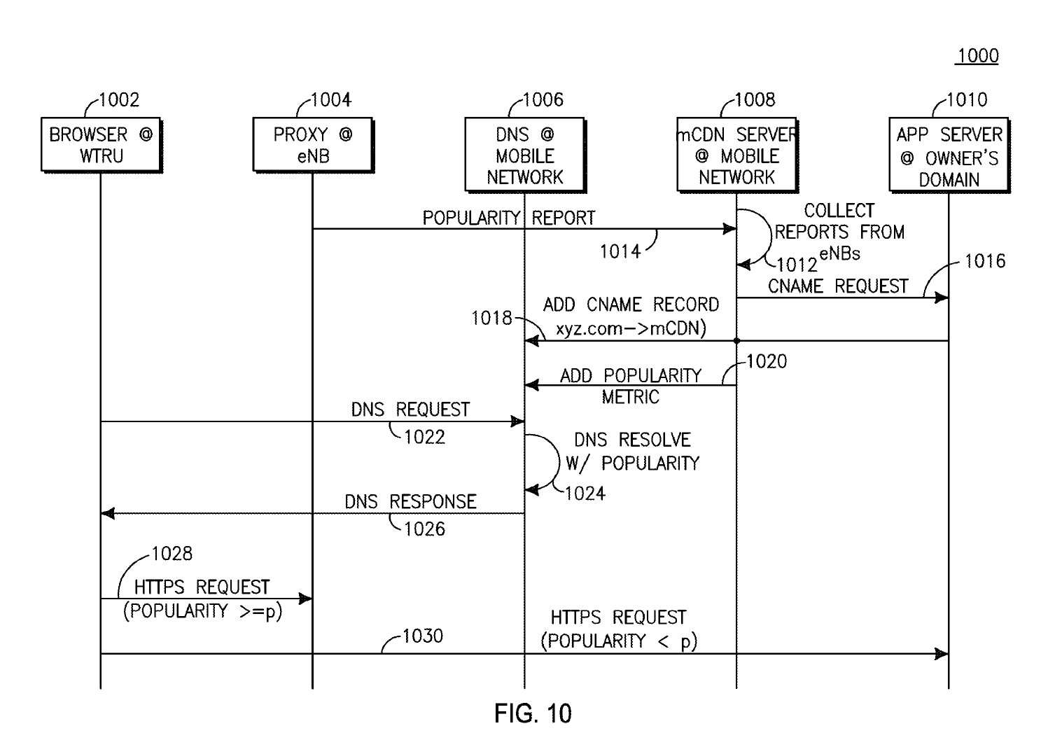

A popularity metric may be used in DNS for HTTPS edge caching, in accordance with the teachings herein. FIG. 10 is a diagram of an example HTTPS request procedure 1000 using a popularity metric. The example HTTPS request procedure 1000 may involve a browser 1002 (for example located at a WTRU), a proxy server 1004 (for example located at an eNB), a DNS server 1006 (for example located in a mobile network), an mCDN server 1008 (for example located in a mobile network), and an application server 1010 (for example located in the application owner's domain).

The mCDN server 1008 may collect domain popularity information 1012 from the proxy at eNB(s) 1004 through popularity reports 1014. The mCDN server 1008 may make a CNAME request 1016 to a content owner 1010 in accordance with the popularity reports 1012. For example, if there is a large enough number of requests to the application server 1010, a request may be made to ask the domain redirection. At 1018, the mCDN server 1008 may add the requested CNAME record (e.g. xyz.com->mCDN.com) to the DNS server 1006, or add it directly by content owner/application server 1010 to DNS server 1006. At 1020, the mCDN server 1008 may add a popularity metric 1020 (determined based on the collected domain popularity information) to the DNS server 1006 for DNS resolution under its own domain (mCDN.com).

If the popularity metric 1020 is greater than or equal to a threshold p, when the browser 1002 makes a DNS request 1022, at 1024, the DNS server 1006 may use a DNS location-based resolution to resolve mCDN.com to the closest IP address. The DNS server 1006 may return the IP address information to the requesting browser 1002 in a DNS response 1026. In this case, the browser 1002 may send its HTTPS request 1028 to the proxy server 1004.

If the popularity metric 1020 is less than the threshold p, at 1024, the DNS server 1006 may return the original content owner 1010's IP address (e.g xyz.com's IP address) in DNS response 1026 as the resolution. In this case, the browser 1002 may send its HTTPS request 1028 directly to the application server 1010. A benefit of the approach in FIG. 10 may be reduced delay of checking cache, where—the CNAME is not always used even if it exists. In the example of FIG. 10, the HTTPS request may not be redirected to the eNB proxy server 1004 first because the SCN content preferences may be diversified. For HTTP traffic, the overhead to redirect to the eNB proxy server 1004 may be acceptable. However, for HTTPS with the need of TLS/SSL session setup, the overhead of redirection may be significant.

Dynamic canonical naming is described herein. A CNAME record may be authorized by the domain owner, for example only the domain owner may create or update a CNAME record in DNS servers.

In the context of a mobile-CDN with small cells, a challenge may be deciding when and how to request content owners to setup a CNAME record in the DNS servers of the mobile network. According to one option, the CDN may set up a business relationship with a big content owner, and the CNAME records may be added statically in the DNS servers used by the content consumers. However, in the mobile-CDN, because there is a small group of users under each edge server, a popular content owner at a small cell may be dynamically changed according to variations to the user group profile. The content owner may be a small player with no pre-established relationship to the mobile-CDN operator. Inserting a CNAME record into the DNS server in a mobile network, which resolves an original content server's domain to the IP address of an edge server, may be performed dynamically by the mobile-CDN operator. The record may only cover one or more small cells, where content from the server may be popular.

A dynamic mechanism may be used to add a CNAME. When content from a domain becomes popular and has potential to be cached, the mobile-CDN service may dynamically request the content owner to add a CNAME record conditionally covering a set of edge servers. At the edge server where an owner's content may be popular, the CNAME may take effect. At edge servers where the owner's content may not be popular, the DNS requests may be directly resolved to the original content server's IP address. In this way, the latency of un-cached content requests may be minimized by use of the CNAME record.

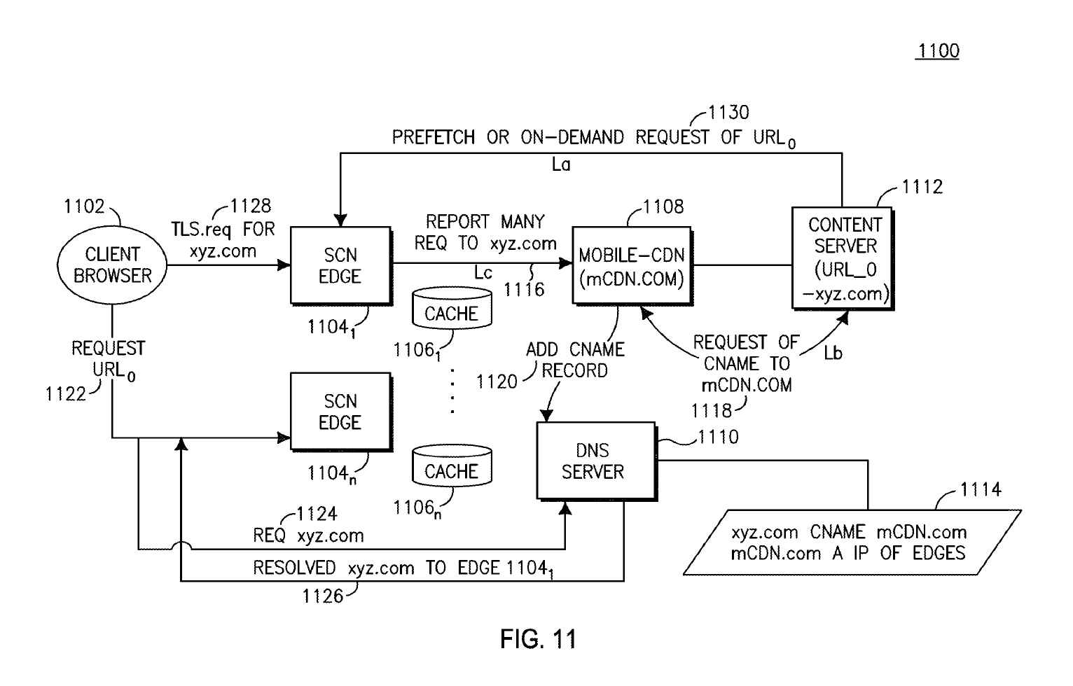

FIG. 11 is a diagram of an example dynamic CNAME procedure 1100. Once edge server 1104₁ detects that there are requests 1124 to xyz.com that meet the threshold to consider caching the requests, a report indicating sufficient requests to xyz.com 1116 may be sent to the mobile-CDN service 1108 (e.g. mCDN.com) via the Lc interface. The mobile-CDN service 1108 may make a request to add a DNS CNAME record 1118, where the request 1118 of mapping xyz.com to mCDN.com may be sent to the content server 1112 through the Lb interface.

The content owner/server 1112 may dynamically agree to have content served by the mobile-CDN service 1108 and may create a CNAME record signed with a private key. This CNAME record may be directly added by the content owner 1112 or indirectly added 1120 by the mobile-CDN service 1108 to the DNS server 1110, which may be inside the mobile network. The DNS server 1110 may ensure the authenticity of the CNAME record by verifying the signature to see if it matches the certificate of the domain 1112.

The mobile-CDN service 1108 may have a service level relationship with the DNS server 1110 in order to have the DNS server 1110 accept a CNAME record signed by the mobile-CDN service 1108 instead of the original content owner 1112. The mobile-CDN service 1108 may act as a form of identity federation facilitating access to the content by adding CNAME records of domain redirections within the mobile network scope. Since the mobile network may make sure all DNS requests first go to the DNS server 1110 of the mobile network, which may be a regular practice for all ISP network operators, CNAME redirection may happen in the mobile network scope.

The CNAME record 1114 that maps xyz.com to mCDN.com may be added at the DNS server 1110. The DNS request to xyz.com 1124 may be resolved in DNS response 1126 in two stages: to domain mCDN.com inside the mobile DNS server 1110, and to mCDN.com to the best edge server's 1104₁ IP address, which may best match the client's 1102 location. The edge server's 1104₁ IP address may be returned by the DNS server 1110, and the browser 1102 may try to setup a TLS session by sending a TLS request 1128 to edge server 1104₁. Since the original URL₀ is in the address bar, the browser 1102 may use the xyz.com certificate to setup the TLS session. If content of URL₀ is in the cache 1106₁ of edge server 1104₁, the end-to-end session may stop at edge server 1104₁ and the HTTP response may contain the requested content. Otherwise, the edge server 1104₁ may request the content of URL₀ from the original content server 1112. In order to increase the cache hit ratio, the edge server 1104₁ may pre-fetch content 1130 (or make an on-demand request of URL₀) from xyz.com at the off-peak hours, based on the recommendation of mobile-CDN service 1108. In another example, the DNS server 1110 may return an anycast IP address of mCDN.com (not shown) and let a network routing protocol determine which edge server 1104₁ . . . 104ₙ is the best to reach by the browser 1102.

Although DNS servers may be hierarchically distributed in the mobile network, the number of DNS servers may be much smaller than the number of small cells. In the case that only one small cell needs the CNAME record, the DNS server may be able to make geo-location based decisions on whether the CNAME record may be used or not for a particular DNS request. For example, with reference to FIG. 11, if a client at edge server 1104ₙ makes a request to URL₀, and the edge server 1104ₙ never before had reported a volume of requests to xyz.com, edge server 1104ₙ may not be caching content from xyz.com. In this case, the DNS server 1110 may not use a CNAME record for this request and may alternatively directly resolve xyz.com to its original server's IP address. For example, if a request is from the edge server 1104ₙ (i.e. the requested content is not cached) the DNS server 1110 may resolve the xyz.com directly to its original server's IP address as well.

To address this challenge, the DNS server in a mobile network may implement a conditional check for a CNAME record lookup request such that only the requests from a collection of source IP addresses may be accepted as valid. Beyond this set, the DNS lookups may refer to a normal record (A record) that may directly resolve xyz.com along the DNS server hierarchy. The conditional check may be updated by the mobile-CDN service according to which edge servers may be possibly caching content from xyz.com. The CNAME record may be set with a timeout period and wait to receive renewal authorization from the content owner. If there are no additional edge servers caching content of a content owner, the corresponding CNAME record may be removed after timeout period.

Dynamic mechanisms may be used for right delegation. The dynamic CNAME may assume a content owner agrees to use the mobile-CDN service and its edge servers as owner-endorsed proxies. After the CNAME record authorization, the content owner may delegate rights to the edge server, so that the TLS session may be setup between the browser and the edge server. The rights delegated to the edge server may include, but are not limited to, any of the following rights.

For example, a right delegation may be an identity delegation via proxy certificate. A proxy certificate may be issued by an end entity certificate (EEC) to perform security actions on behalf of the end entity. Since a proxy certificate may have restricted rights defined within its own “policyLanguage” field and a shorter life time, the security risk of being compromised may be much lower than the risk of the original end entity certificate being compromised.

In another example, a right delegation may be a privilege delegation via attribute certificate. An attribute certificate may be issued by an end entity A (Issuer) to bundle certain privileges of entity A (attributes) to another end entity B (Holder). An attribute certificate may only indicate that the issuer gives limited privileges to the holder within a limited time period that may be much shorter than the life time of the issuer's certificate. The security risk of a compromised attribute certificate may be limited to one holder and over a short period of time.

In another example, a right delegation may be direct session key delegation through an on-demand interaction between an edge server and a content owner. Without a delegated certificate, an edge server that may have received a TLS session setup request after the DNS redirection based on CNAME record, may relay the TLS session setup messages to the content server and request the session key through a different interface or message. A content owner who may agree to redirect its traffic to an edge server, may be assumed to be willing to share the session key with the same edge server. The security risk of this approach is per-session and the content server may impose a timeout at the session setup to limit the risk in case an edge server is compromised.

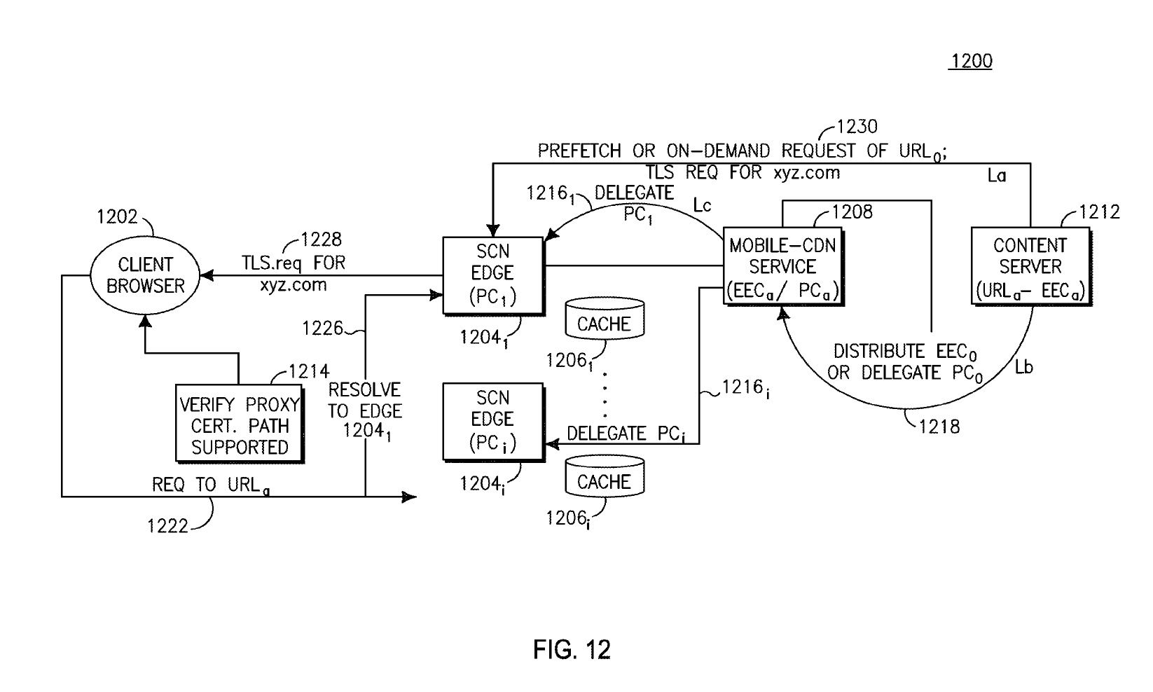

Mechanisms may employ identity delegation by issuing proxy certificates, as described below. FIG. 12 is a diagram of an example proxy certificate delegation procedure 1200. In response to a request from the mobile-CDN service 1208 for CNAME record authorization (through interface Lb, not shown in FIG. 12) the content owner 1212 may issue or delegate a proxy certificate PC₀ 1218 to the mobile-CDN service 1208 and may allow the mobile-CDN service 1208 to further issue a proxy certificate PCᵢ 1216₁ . . . 1216ᵢ to any numbers of edge servers 1204₁ . . . 1204ᵢ via interface Lc, where proxy certificate PCᵢ applies to edge server 1204ᵢ for example. For example, the content owner 1212 may trust the mobile-CDN service 1208 by allowing it to procure its original certificate EEC₀ 1218 since the mobile-CDN service 1208 may run at a secure environment. Edge servers 1216₁ . . . 1216ᵢ may not further procure the original certificate EEC₀ due to the high security risks, as described above.

Referring to the example of FIG. 12, when a browser 1202 under edge server 1204₁ requests access to HTTPS content URL₀ 1222, the domain of URL₀, xyz.com, may be resolved at 1226 to the IP address of edge server 1204₁. The browser 1202 may send a TLS session request 1228 to the edge server 1204₁ for HTTPS request to URL₀. When the proxy certificate PC₁ is used by the edge server 1204₁ for TLS session setup, the browser 1202 may verify PC₁ at 1214 to see if a trusted CA is in the path of PC₁, (as shown if FIG. 6, for example). If the content identified by URL₀ is available in the cache, the content may be directly responded to as an HTTP response over TLS session to the browser 1202. Otherwise, the edge server 1204₁ may setup a TLS session (not shown) to the original content server 1212. An HTTPS response for URL₀ may be received by edge server 1204₁ and may be relayed to the browser 1202. The content in the cache 1206₁ of an edge server 1204₁ may be pre-fetched 1230 via interface La from the content server 1212, based on the recommendation of the mobile-CDN service 1208.

In an example, a browser implementation may support verification of a proxy certificate chain for TLS session setup. As in the case of the example in FIG. 12, a proxy certificate (PC) path verification procedure may be same as that of an end entity certificate (EEC): the lowest level CA that signs the ECC may be considered trustworthy, implying that the certificate may be considered valid. The PC may differ from an EEC in that the subject field of the PC may contain a prefix of an issuer name plus a unique name for the PC holder. To verify a PC, the TLS function in the browser program may be implemented to do any one or more of the following: match the domain to be verified with the prefix of the subject field; verify the issuer's EEC; and/or check the ProxyCertInfo extension about policy inherit option to determine the certificate policy for the PC.

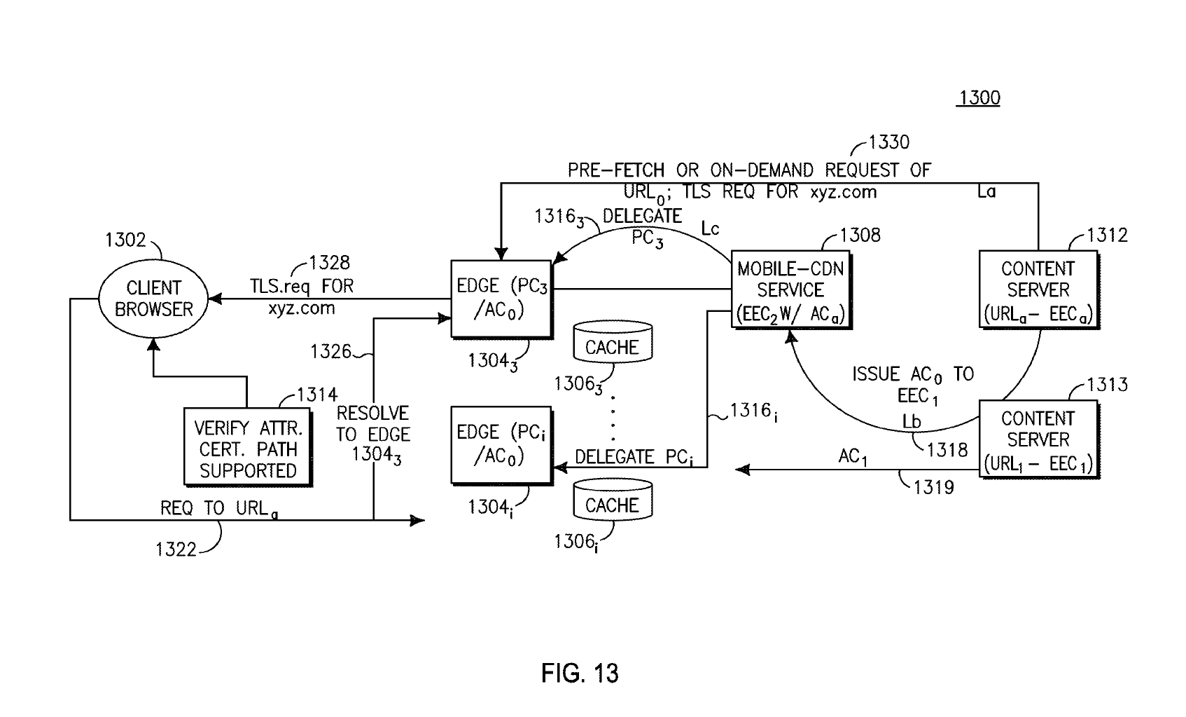

Mechanisms may employ privilege delegation via issuing attribute certificates (ACs) as a right delegation. FIG. 13 is a diagram of an example attribute certificate delegation procedure 1300 to a mobile-CDN service. In response to receiving the request of right delegation (not shown) and/or a CNAME request (not shown) from mobile-CDN service 1308, instead of issuing a proxy certificate, a content owner 1312 may delegate a privilege 1318 to the mobile-CDN service 1308 by bundling an attribute certificate AC₀ with the mobile-CDN service's 1308 end entity certificate EEC₂ (or AC₁ by EEC₂ in 1319). The attribute certificate AC₀ may include a privilege assigned to the mobile-CDN service 1308, for example a caching privilege, which may be defined as a right to host a TLS session requested from a browser.

The mobile-CDN service 1308 may issue delegate proxy certificates 1316₃ . . . 1316ᵢ (e.g. PC₃ . . . PCᵢ) to edge servers 1304₃ . . . 1304ᵢ with the inherent attribute certificate AC₀. When the browser 1302 tries to access URL₀ 1322, the request may be redirected to edge server 1304₃ based on DNS resolution 1326. The edge server 1304₃ holds PC₃ with AC₀. Then the browser 1302 may attempt a TLS session by sending a TLS request for xyz.com 1328 to edge server 1304₃. As part of the certificate verification 1314, the browser 1302 may retrieve a PC₃ certificate path until EEC₁ and may see AC₀ is a bundled attribute certificate signed by EEC₀, the original certificate of the owner. The browser 1302 may choose to pass the certificate verification and may allow the edge server 1304₃ using PC₃ to establish the TLS session for content URL₀. If the content is in the cache 1306₃, it may be responded to by the edge server 1304₃, or the edge server 1304₃ may obtain the content from the original server 1312 through pre-fetch or on-demand requests to URL₀, 1330.

An advantage of using an AC instead of a PC may include that an edge server may use one EEC or PC to prove its privileges from multiple content owners. For example, with reference to FIG. 13, edge server 1304₃ may not need a proxy certificate rooted by both EEC₀ and EEC₁. PC₃ may be created independently of content owners 1312 and 1313. Edge server 1304₃ may inherit privileges of AC₀ and AC₁ from EEC2.

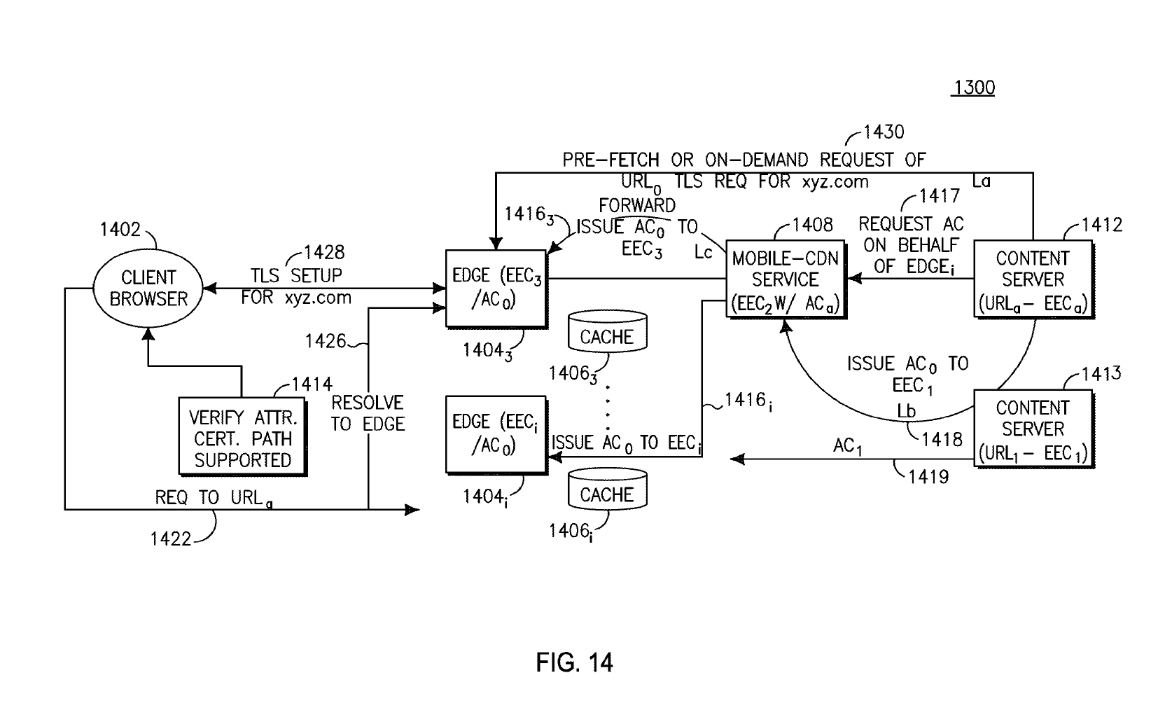

Another way to use an AC is to direct bundle an edge server's EEC with the content owner issued AC. FIG. 14 is a diagram of an example attribute certificate delegation procedure 1400 acting directly to edge servers. The mobile-CDN service 1408 may send a request message 1417 to request an AC with a caching privilege to content server 1412 on behalf of edge servers 1404₃ . . . 1404ᵢ via interface Lb. For example, a mobile-CDN service 1408 may request AC₀ for edge server 1404₃. In this case, the attribute certificate AC₀ may be directly bundled with EEC₃ and AC₀ and EEC₃ may be forwarded 1416₃ to edge server 1404₃ via interface Lc. When the browser 1402 tries to request URL₀ 1422, the request 1422 may be redirected or resolved 1426 to edge server 1404₃. During the TLS session setup 1428, the browser 1402 may check EEC₃ given by edge server 1404₃ and may find AC₀ is bundled with EEC₃. The browser 1402 may verify AC₀ is issued by EEC₀ that matches the domain name of URL₀, xyz.com in the verification process 1414.

The browser 1402 may pass the certificate verification and may allow the edge server 1404₃ using EEC₃ to establish the TLS session for content URL₀. If requested HTTPS content is in the cache 1406₃, the browser 1402 may be responded to by the edge server 1406₃. If the content is not in the cache 1406₃, the edge server 1404₃ may obtain the content from the original URL₀ via interface La via a pre-fetch or on demand request 1430. The same process may happen if a client browser 1402 gains access through any other edge server 1404ᵢ with cache 1406ᵢ, which may obtain AC₀ issued by mCDN service 1408 through 1416ᵢ. The same process may also happen if a client browser 1402 requests to any other content server 1413 that may issue an attribute certificate AC₁ 1419 to mobile-CDN service 1408.

A challenge of using AC may be the browser support of AC path verification 1414. Since the holder field of an AC may contain no prefix of the issuer's information, as described above, the holder field of the AC may not be used directly for identity verification. To overcome this problem, the browser 1402 TLS function may be implemented with additional features, including, but not limited to, any of the following: tracking the entity's certificate path until the AC's holder matches the subject of a certificate on the path; tracking the AC holder's certificate path until a trustworthy CA is found; checking the AC's issuer if its subject field matches the domain TLS session targets, and if so, use the entity certificate to establish the TLS session to the edge server. For example, in FIG. 13 (and similarly FIG. 14), a certificate verification process 1314 for TLS session setup in the browser 1302 may do any of the following: check AC₀ on PC₃ and may find EEC₂ is the holder of AC₀; track the EEC₂ path and find the mobile-CDN CA is on the path and trusted; check AC₀'s issuer EEC₀ and find its subject field is xyz.com; and/or track the EEC₀ path and find, for example, Verisign CA is on the path and trusted. Based on the verification, the browser 1302 may know any of the following information: PC₃ is a trusted proxy certificate; AC₀'s issuer EEC₀ is a trusted end entity certificate and may match the domain that it needs to setup the TLS session. The TLS session may be setup using PC3 as an authorized representative of domain xyz.com.

Mechanisms may be used for on-demand session key delegation as a right delegation. Certificate delegation may pose a risk for identity theft. Once the identity and/or privilege are delegated, the edge server may use them to serve any content on behalf the content owner. The content owner may lose control during the valid time period of the certificate and implementing a certificate revoking mechanism may be costly.

As a possible solution, the content owner may choose to release the key of a TLS session key to an edge server and may restrict sending only cacheable content responses over the TLS session.

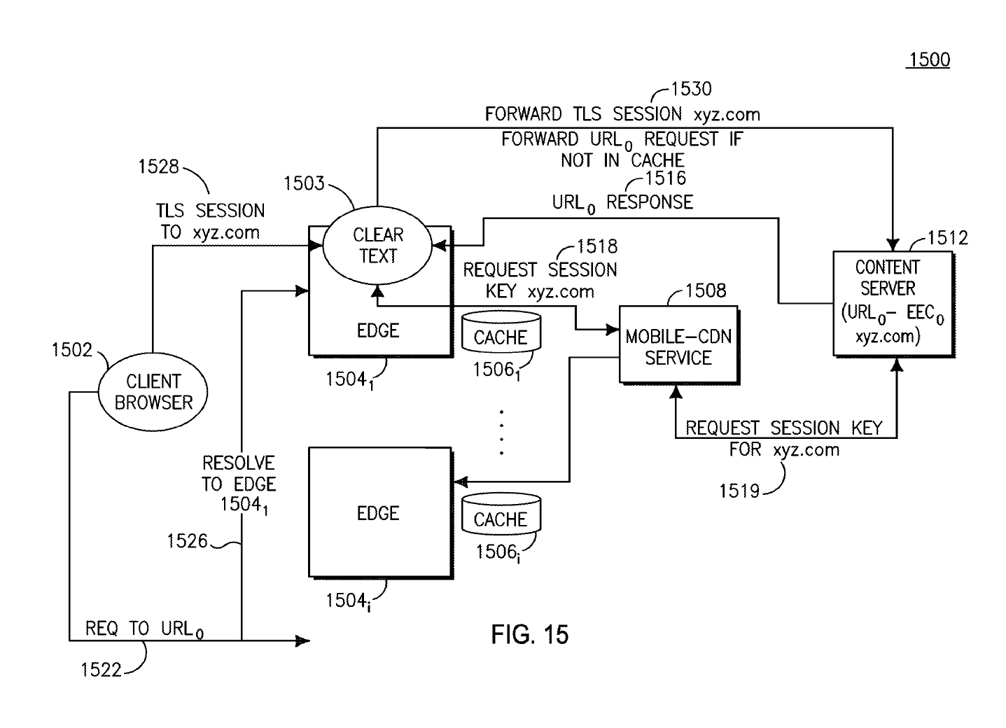

FIG. 15 is a diagram of an example on-demand session key delegation procedure 1500. After a content owner 1512 authorizes a CNAME record to mobile-CDN service 1508, the browser 1502 may request URL₀ 1522, and the request 1522 may be resolved to edge server 1504₁, shown in 1526. The browser 1502 may send a TLS session establishment request 1528 to edge server 1504₁. Edge server 1504₁ may forward the TLS session request 1530 to a content server 1512 because it may not have any certificate for domain xyz.com. Edge server 1504₁ may relay the TLS session setup process between the browser 1502 and content server 1512 until the session is established. The messages of TLS session setup may be in clear text 1503 although the payload may contain encrypted data by the private key of the content server 1512's certificate EEC₀.

Edge server 1504₁ may send a request to possess the session key 1518 and 1519 via mobile-CDN service 1508 to content server 1512. Instead of or in addition to delegation of a certificate, the content server 1512 may delegate the session key dynamically upon edge server's 1504₁ request 1518 relayed by mobile-CDN service 1508 in request 1519. With the session key, edge server 1504₁ may decrypt and re-encrypt HTTPS requests and responses over the TLS session, which may allow edge server 1504₁ to serve content of URL₀ request 1522 in clear text 1502 if it is in the cache 1506₁. If the content is not in the cache 1506₁, at 1530, the edge server 1504₁ may forward the URL₀ request to content server 1512 over an encrypted session using the obtained session key. The session key may also allow edge server 1504₁ to see the URL₀ response in clear text 1503 and store the content in the clear text response 1503 in cache 1506₁.

In the scenarios and using the mechanisms described above, a TLS session may be between a browser and the content server. There may be multiple sessions through an edge server. The edge server may manage the TLS sessions and may identify each session when there is a request for the session key. A session may have a short life time. The content server may terminate a session at any time. Compared with certificate delegation, this session key delegation approach may have even less security risk to content owners.

A challenge associated with session key delegation may include the delay of session setup and the key distribution to edge servers. Even if a content item exists in the cache of an edge server, if no TLS session exists for the domain, the browser may only get the content from the cache until the TLS session is setup between browser and edge server, which may occur after the edge server gets the session key from the content server. Since every HTTPS request may use a TLS session setup, the delay on session key delegation may be significant for small sized content. For large sized content, such as a long video clip, the initial delay on session key delegation may be negligible.

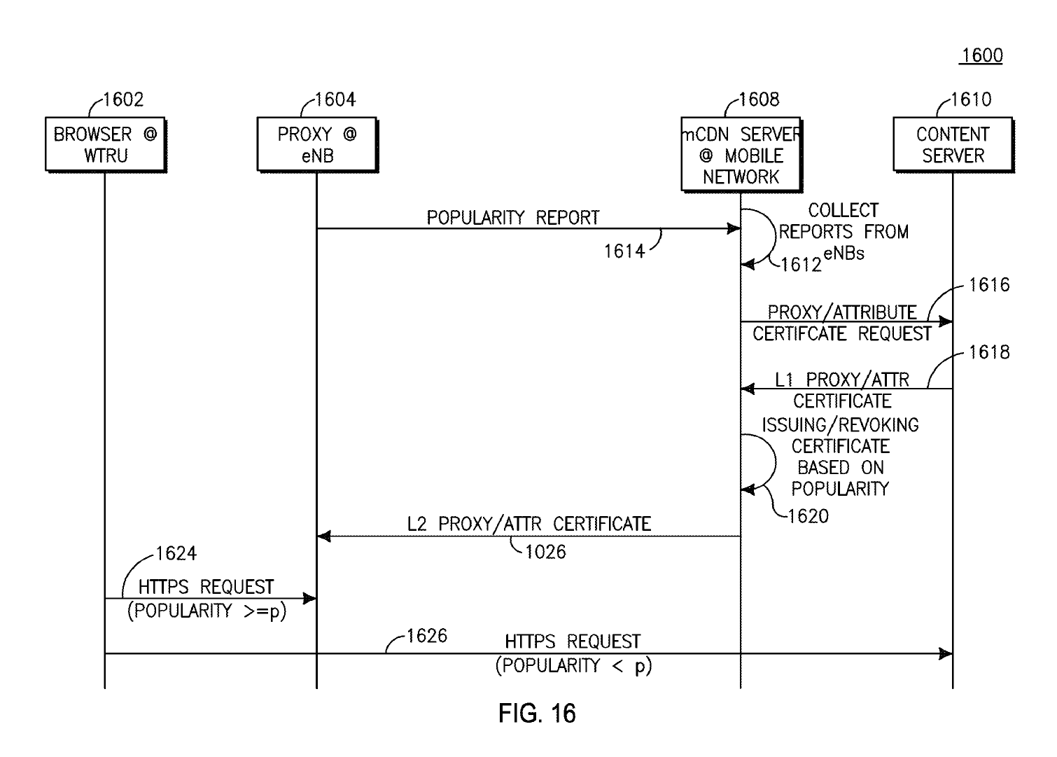

A multi-level proxy/attribute certificate issuing architecture may be used with the teachings herein. FIG. 16 is a diagram of an example multi-level certificate management procedure 1600. The example procedure 1600 shows mechanisms to issue and/or revoke proxy/attribute certificates in small cell network (SCN) and/or Mobile-CDN server 1608, which may be in sync with DNS with popularity metric as described in FIG. 10. The example procedure 1600 in FIG. 16 may involve a browser 1602 (for example located at a WTRU), a proxy server 1604 (for example located at an eNB), an mCDN server 1608 (for example located in a mobile network), and a content server 1610 (for example located in the application owner's domain).

The mCDN server 1608 may collect popularity reports 1612 and 1614 from eNBs. At level 1 (L1), the mCDN server 1608 may send to the domain owner/content server 1610 (e.g. xyz.com) a request for a long term proxy/attribute certificate 1616. At level 2 (L2), the mCDN server 1608 may issue/revoke 1620 an L2 short term proxy/attribute certificate to an eNB depending on the popularity of the domain xyz.com for the small cell associated with the domain xyz.com. The mCDN server 1608 may distribute the L2 proxy/attribute certificate 1622 to the corresponding proxy server 1604 at an eNB. This approach may result in a least exposure on owner's right with reduced burden on the domain owner/content server 1610 to issue/revoke proxy/attribute certificates frequently. When browser 1602 makes an HTTPS request to content server 1610 (xyz.com), if the domain xyz.com popularity is above a threshold p at the closest proxy server 1604, the HTTPS request may be redirected as HTTPS request 1624 to the proxy server 1604. If the popularity of domain xyz.com is below the threshold p at proxy 1604, the request may be sent directly to the content server 1610 via HTTPS request 1626.

An SCN eNB (e.g. WiFi AP) may be less trustworthy, such that cautious right delegation may minimize the abuse of using the content owner's right. In this case, it may be the mobile-CDN's task to maintain the good standing of eNBs, and this may be in place of content owners/servers.

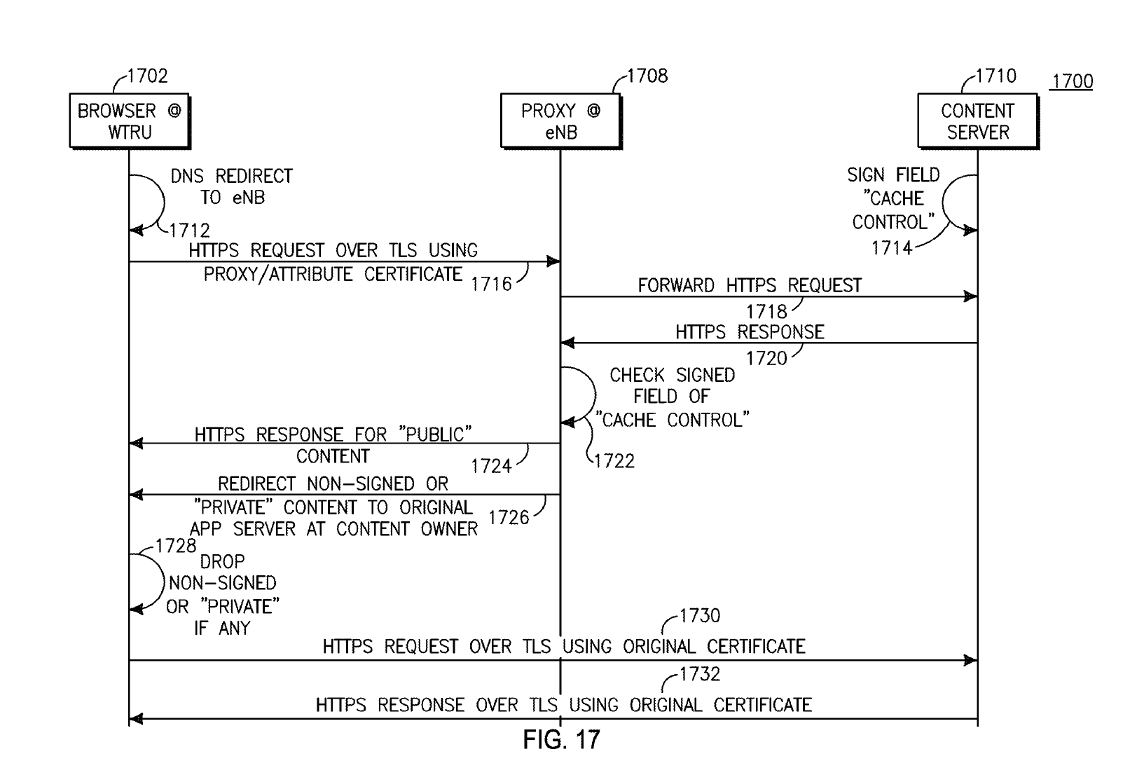

Mechanisms may provide a secure way to use TLS/SSL session over non-original certificate. FIG. 17 is a diagram of an example procedure 1700 over non-original certificate. The content owner 1710 may sign a “cache_control” field 1714 in a header of an HTTPS response 1720 upon request 1718, and the original URL of the content owner 1710 may be included in the signed field. The proxy server 1708 may check the “cache_control” field 1722. If the field is signed by the content owner 1710 and it is publically cacheable, the proxy server 1708 may store the content in cache or serve it from the cache in the HTTPS response 1724. The proxy server 1708 may respond to the browser's 1702 HTTPS request 1716 with a redirect link 1712 indicating redirection to original server 1710. When HTTPS request is redirected 1712, and a non-original certificate is used for TLS session setup 1716, the browser 1702 may also check “cache_control” field 1722, and may accept HTTPS content if the “cache_control” field is signed by the content owner 1710 and/or the content is publically cacheable. If the “cache_control” field in the HTTPS response fails the “cache_control” field check at 1722 or 1728, the browser 1702 may get the HTTPS content from the original content server 1710 using original certificate, using an HTTPS request 1730 and HTTPS response 1732 exchange. The approach shown in FIG. 17 may preserve privacy but provide savings if large percentage of content is publically cacheable on HTTPs sites, which is true in many cases.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A domain name server (DNS) in a mobile content distribution network (mCDN) comprising:
a storage configured to store an A record of an original domain of a content owner, wherein the A record maps the original domain to an associated IP address;
a processor configured to add or remove a canonical name (CNAME) record that maps the original domain of the content owner to another domain of the mCDN;
a receiver configured to receive a popularity metric indicating a popularity of the original domain at a plurality of edge servers of the mCDN from an mCDN server;
the receiver further configured to receive a DNS request for the original domain;
the processor further configured to generate a location determination by determining if the DNS request is associated with an edge server of the plurality of edges servers based on a source location of the DNS request relative to a location of the edge server;
the processor further configured to determine a DNS resolution for the DNS request to be derived from one of the CNAME record or the A record based on the popularity metric and the location determination; and
a transmitter configured to send a DNS response with the DNS resolution.

2. The DNS of claim 1, wherein the popularity metric is based on a plurality of popularity reports associated with the plurality of edge servers of the mCDN.

3. The DNS of claim 1, wherein the plurality of edge servers are respectively located in a plurality of evolved Node Bs (eNBs) of a mobile network.

4. The processor in claim 1, wherein the processor is further configured to determine the DNS resolution for the DNS request comprises:
comparing the popularity metric with a predetermined threshold;
on a condition that the popularity metric is greater than or equal to the predetermined threshold, providing an IP address of the edge server of the mCDN as the DNS resolution using the CNAME record; and
on a condition that the popularity metric is not available for a domain of the edge server, or on a condition that the popularity metric is less than the predetermined threshold, providing the associated IP address of the original domain as the DNS resolution using the A record.

5. The DNS of claim 1, wherein the mCDN is within a mobile network.

6. The DNS of claim 1, further comprising:
the receiver configured to receive a request to dynamically add or remove the CNAME record for the domain from an mCDN server.

7. The DNS of claim 1, wherein the DNS request is received from a client browser and wherein the DNS response with the DNS resolution is sent to the client browser.

8. A method performed by a domain name server (DNS) in a mobile content distribution network (mCDN) comprising:
storing an A record of an original domain of a content owner, wherein the A record maps the original domain to an associated IP address;
adding or removing a canonical name (CNAME) record that maps the original domain of the content owner to another domain of the mCDN;
receiving a popularity metric indicating a popularity of the original domain at a plurality of edge servers of the mCDN from an mCDN server;
receiving a DNS request for the original domain;
generating a location determination by determining if the DNS request is associated with an edge server of the plurality of edges servers based on a source location of the DNS request relative to a location of the edge server;
determining a DNS resolution for the DNS request to be derived from one of the CNAME record or the A record based on the popularity metric and the location determination; and
sending a DNS response with the DNS resolution.

9. The method of claim 8, wherein the popularity metric is based on a plurality of popularity reports associated with the plurality of edge servers of the mCDN.

10. The method of claim 8, wherein the plurality of edge servers are respectively located in a plurality of evolved Node Bs (eNBs) of a mobile network.

11. The method of claim 8, wherein the determining the DNS resolution for the DNS request comprises:
comparing the popularity metric with a predetermined threshold;
on a condition that the popularity metric is greater than or equal to the predetermined threshold, providing an IP address of the edge server of the mCDN as the DNS resolution using the CNAME record; and
on a condition that the popularity metric is not available for a domain of the edge server, or on a condition that the popularity metric is less than the predetermined threshold, providing the associated IP address of the original domain as the DNS resolution using the A record.

12. The method of claim 8, wherein the mCDN is within a mobile network.

13. The method of claim 8, further comprising:
receiving a request to dynamically add or remove the CNAME record for the domain from an mCDN server.

14. The method of claim 8, wherein the DNS request is received from a client browser and wherein the DNS response with the DNS resolution is sent to the client browser.

15.-26. (canceled)
